(19) United States
(12) Patent Application Publication
(10) Pub. No.: US 2018/0302351 A1
(43) Pub. Date: Oct. 18, 2018

(54) Messaging System, Method and Computer Program Product

(71) Applicant: Microsoft Technology Licensing, LLC, Redmond, WA (US)

(72) Inventors: Deepak Kumar PRATINIDHI, Hyderabad (IN); Rajiv KUMAR, Hyderabad (IN); Prashant GUPTA, Hyderabad (IN); Vinay KUMAR, Hyderabad (IN); Rakesh MIDHA, Hyderabad (IN); Shashank AGARWAL, Hyderabad (IN); Ashwani JINDAL, Hyderabad (IN); Jayawant TEWARI, Bangalore (IN); Paramveer Singh SISODIA, Hyderabad (IN); Arun RAJAPPA, Hyderabad (IN); Manav MITHAL, Hyderabad (IN); Richa ARORA, Hyderabad (IN)

(73) Assignee: Microsoft Technology Licensing, LLC, Redmond, WA (US)

(21) Appl. No.: 15/611,600

(22) Filed: Jun. 1, 2017

(30) Foreign Application Priority Data
Apr. 12, 2017 (IN) 201741013192

(51) Int. Cl. H04L 12/58; H04L 29/08

(52) U.S. Cl. CPC H04L 51/04; H04L 67/306

(57) ABSTRACT

A messaging system provides messaging interactions between users of a group. A message received from a subscriber user and intended for an administrator user is routed to an administrator user, the message not being visible to other subscriber users. A message received from an administrator user and intended for a specific subscriber user is routed to the specific subscriber user, the message not being visible to other subscriber users. A message received from an administrator user and intended for plural subscriber users is routed to the plural subscriber users. A subscriber user is unable to send a message to another subscriber user via the messaging system.

### CROSS REFERENCE TO RELATED APPLICATION

This application claims the benefit under 35 U.S.C. § 119(a) and 37 CFR § 1.55 to IN Patent Application Serial No. 201741013192, filed on Apr. 12, 2017, the entire disclosure of which is incorporated herein by reference.

### TECHNICAL FIELD

The present disclosure relates to a messaging system, method and computer program product.

### BACKGROUND

A messaging (or chat) system allows users of the messaging system to exchanges messages with other users of the messaging system. The messages are primarily text-based, but can also comprise rich content such as images, videos, documents, audio, etc. This is sometimes referred to as instant messaging, which refers to the fact that the messaging takes place in real time, with messages being transferred very quickly and often perceived by users to be transferred and delivered almost or practically instantaneously. That is, there is typically only a short delay (e.g. about two seconds or less, and typically much less) between a user sending a message and it being received by its intended recipient(s). The messages are transmitted and received via a network, which may include the Internet.

Other rich functionality, such as collaborative documents editing, poll creation, etc., may also be provided within the messaging system.

The users have messaging accounts held within the messaging system and which they use to access the messaging system.

Within the messaging system, messaging groups may be provided. Multiple users may be participants in a messaging group. The participants' messaging accounts are associated with the messaging group. A group structure provides a convenient way for users with for example a common interest to communicate with each other using a messaging service of the messaging system. For example, the messaging service may comprise a messaging server which relays messages between users in the group or a look-up server which allows network addresses of the users to be obtained so that messages can be sent between them directly.

There is a growing demand for a messaging system that enables a (very) large number of users to have some participation in a messaging group. However, it has been found that current messaging systems, such as instant messaging (IM) systems, are not suitable for use when there is a (very) large number of users, and are often limited in their functionality.

### SUMMARY

According to a first aspect disclosed herein, there is provided a messaging system providing for messaging interactions between users of a group, the system comprising:

a subscriber segment constructed and arranged to store subscription information for subscriber users, a subscriber user being a user who has subscribed to the group;

a user segment comprising a user message router constructed and arranged to receive messages from subscriber users for routing the messages received from subscriber users to one or more administrator users, an administrator user being a user who is an administrator of the group;

the messaging system being configured such that a message received from a subscriber user and intended for an administrator user is routed to an administrator user, the message not being visible to other subscriber users;

the messaging system being configured such that a message received from an administrator user and intended for a specific subscriber user is routed to the specific subscriber user, the message not being visible to other subscriber users;

the messaging system being configured such that a message received from an administrator user and intended for plural subscriber users is routed to the plural subscriber users; and

the messaging system being configured such that a subscriber user is unable to send a message to another subscriber user via the messaging system.

In some examples, this provides significant features and advantages that are not possible with typical known messaging systems. For example, administrators can support a large number of individual unrelated interactions with subscribers in a group context. The interactions or conversations between an administrator and a subscriber may be formatted so as to appear to the subscriber as if the conversation is between the subscriber user and a virtual entity (i.e. the “group”), rather than some specific person (such as the human administrator). For the administrators, the experience is that the administrative users will see a bunch of messages/actions posted into the group, which are often to be acted upon one way or another by the administrators.

The message received from an administrator user and intended for a specific subscriber user may be for example a reply to a message received from the subscriber user by that or another administrator user.

In an example, the messaging system is arranged such that that a message received from an administrator user and intended for all of the plural subscriber users is routed to all of the plural subscriber users.

In an example, the messaging system is arranged such that a message received from an administrator user and intended for a filtered set of plural subscriber users is routed to the filtered set of plural subscriber users. The filtering may be based on for example one or more of the user profiles, location and demography.

In an example, the user segment is constructed and arranged to store message information for messages received from subscriber users. In an example, the user segment is constructed and arranged to store, for at least some messages, message information that includes at least the category of the subscriber user who sent the message. The message information stored by the user segment may include the or at least some of the content of the message and/or the user category for the subscriber user who sent the message so that the organizational side of the group can appropriately visualize it and pass it to an appropriate administrator.

In an example, the subscriber segment is constructed and arranged to store subscription information for subscriber users in plural blocks, each block containing subscription information for a different subset of the subscriber users. In an example, the subscriber segment comprises a subscriber message router, the messaging system being configured such that a message received from an administrator user and intended for plural subscriber users is routed by the subscriber message router to the plural subscriber users in plural blocks corresponding to the plural blocks containing subscription information for different subsets of the subscriber users

In an example, the messaging system comprises a members segment, the members segment comprising a router arranged to route a message received from an administrator user and intended for other administrator users. The members segment may also handle the sending of messages between “full” members and between full members and administrators, full members being users who have fully joined the group (rather than simply being subscribers to the group) and are therefore able to send messages to and receive messages from other full members who have joined the group as well as send messages to and receive messages from administrators.

In an example, the messaging system is constructed and arranged to store membership information for administrator users, the router being arranged to route a message received from an administrator user and intended for other administrator users in accordance with the membership information stored for administrator users. Membership information may include at least contact details for administrator users that enables messages to be sent to administrator users.

In an example, the members segment is constructed and arranged to store at least messages sent by an administrator user to other administrator users.

In an example, the messaging system is arranged such that the group is publicly discoverable by users who are not currently subscribers to the group.

In an example, the messaging system is arranged such that the group is publicly discoverable by users based on the location of the user.

According to a second aspect disclosed herein, there is provided a method of operating a messaging system for messaging interactions between users of a group, the system comprising a subscriber segment in which subscription information for subscriber users is stored, a subscriber user being a user who has subscribed to the group, and the system comprising a user segment comprising a user message router constructed and arranged to receive messages from subscriber users for routing the messages received from subscriber users to one or more administrator users, an administrator user being a user who is an administrator of the group, the method comprising:

receiving a message from a subscriber user and intended for an administrator user and routing the message to an administrator user such that the message is not visible to other subscriber users;

receiving a message from an administrator user and intended for a specific subscriber user and routing the message to the specific subscriber user such that the message is not visible to other subscriber users; and

receiving a message from an administrator user and intended for plural subscriber users and routing the message to the plural subscriber users;

wherein the messaging system is configured such that a subscriber user is unable to send a message to another subscriber user via the messaging system.

According to a third aspect disclosed herein, there is provided a computer program product for a messaging system for messaging interactions between users of a group, the system comprising a subscriber segment in which subscription information for subscriber users is stored, a subscriber user being a user who has subscribed to the group, and the system comprising a user segment comprising a user message router constructed and arranged to receive messages from subscriber users for routing the messages received from subscriber users to one or more administrator users, an administrator user being a user who is an administrator of the group, the computer program product being embodied on a computer-readable storage device and configured so as when executed on a processor of the device to perform operations comprising:

receiving a message from a subscriber user and intended for an administrator user and routing the message to an administrator user such that the message is not visible to other subscriber users;

receiving a message from an administrator user and intended for a specific subscriber user and routing the message to the specific subscriber user such that the message is not visible to other subscriber users; and

receiving a message from an administrator user and intended for plural subscriber users and routing the message to the plural subscriber users;

wherein the messaging system is configured such that a subscriber user is unable to send a message to another subscriber user via the messaging system.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a messaging system;

FIG. 2 shows schematically an example of segments in the messaging system;

FIG. 3 shows schematically an example of a hub-and-spoke model of an example of the messaging system; and

FIGS. 4, 5, and 6 show schematic examples of the flow of messages.

### DETAILED DESCRIPTION

As mentioned, a messaging (or chat) system allows (human) users of the messaging system to exchanges messages with other users of the messaging system. The messages are often primarily text-based, but can also comprise rich content such as images, videos, documents, audio, etc. This is sometimes referred to as instant messaging, which refers to the fact that the messaging takes place in real time, with messages being transferred very quickly and often perceived by users to be transferred and delivered almost or practically instantaneously. Other rich functionality, such as collaborative editing of documents, poll creation, publishing surveys for users, etc., may also be provided within the messaging system. Within the messaging system, messaging groups may be provided and multiple users may be participants in a messaging group. The participants' messaging accounts are associated with the messaging group. A group structure provides a convenient way for users with for example a common interest to communicate with each other using a messaging service of the messaging system.

In known messaging systems, messages are typically sent between users on a one-to-one basis. That is, one user is able to send a message to one and only one other user at a time. This can be regarded as a type of ring topology. Moreover, in known messaging systems, messages are typically not visible to users other than the sender and the recipient. In addition, in known messaging systems, the group as a whole is often a closed system in that users who are not members of the group cannot see the group and cannot even discover the existence of the group (via for example internet search engines and the like).

There is a growing demand for a messaging system that enables a (very) large number of users to have some participation in a messaging group. However, this is not possible with current messaging systems. This is for a number of reasons, including the nature of the way that messages are handled by current messaging systems which prevents current messaging systems being scalable to handle having a (very) large number of users participate in some way with the group. There is also a growing demand for a messaging system that enables users to participate in different ways from what has been possible with known messaging systems.

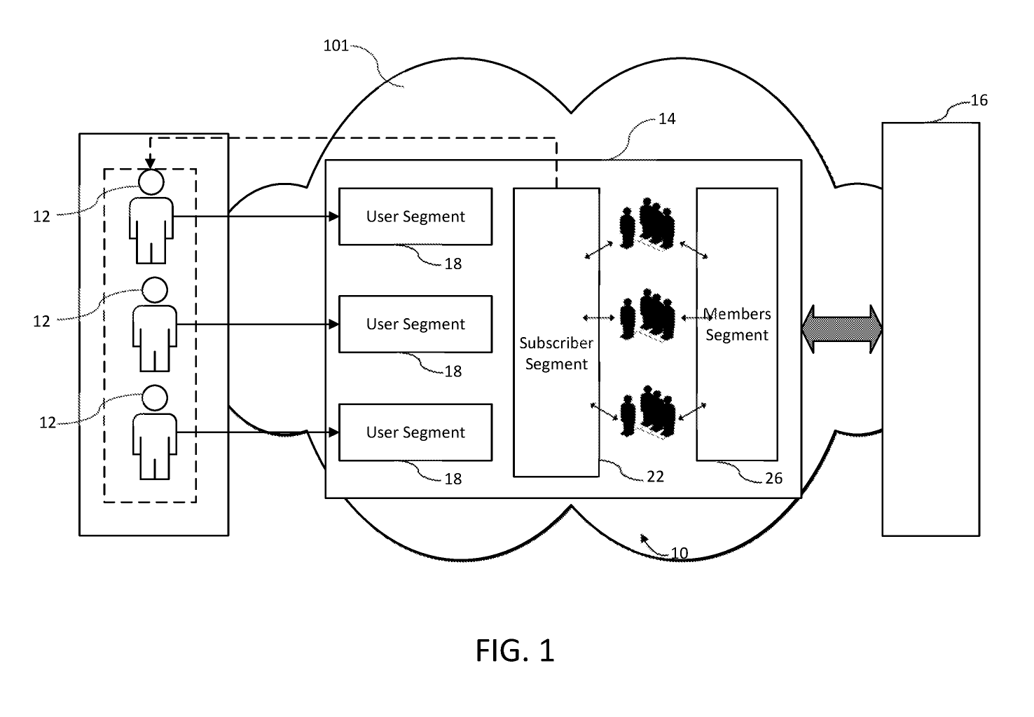

FIG. 1 shows schematically an example of a messaging system 10 according to the present disclosure. The messaging system 10 shown is suitable for handling a large number of users who wish to participate in some way in a particular group, as discussed further below.

A “group” in this context is a group of users who are interested in a particular subject or in a particular organisation say. The organisation may be for example a particular business organisation (such as a particular company or set of companies, or a trade body or the like). The organisation may be for example a local or regional or national government authority or the like. Many other examples of groups are possible. The term “group” as used herein is in some senses a logical structure. Nevertheless, the group is controlled by one or more (computer) processors of the messaging system to operate according to one or more rules, which are typically different between different groups. For example, messages between users of different groups may be handled differently under control of the one or more processors, with for example message routers of the computer apparatus being controlled to operate accordingly.

It may be noted that a group may contain other groups as members of the group, in addition to (human) users being members of the group. Such a hierarchical grouping structure is described more fully in our Indian patent application no. 201641024648 and our U.S. patent application Ser. No. 15/397,145, the entire contents of which are incorporated herein by reference.

The messaging system 10 enables communication to and from user terminals or devices 12 associated with the various users over a network. The network may be a single network or composed of one or more constituent networks, including for example the Internet. Alternatively or additionally, the network 101 may comprise a wireless local area network (WLAN), a wired or wireless private intranet (such as within a company or an academic or state institution), and/or the data channel of a mobile cellular network. In an embodiment a user device 12 is able to access the messaging system 10 via a mobile or cellular network.

The user devices 12 may be for example a smartphone, a laptop or desktop computer, a tablet device, or other similar device that enables a user to connect to and use the messaging system 10. The user devices 12 typically have a processor, such as a central processing unit (CPU), volatile memory, non-volatile data storage such as a hard disk and/or non-volatile memory or the like, a network interface circuit which enables the device to connect to a network, a display, as well as one or more input devices, such as a keyboard, trackpad, touchscreen, touchpad, etc. Further input/output devices may also be provided, for example for receiving audio and/or video information from the user, such as a microphone and a camera, and one or more speakers or other audio playback device. The user devices 12 may have an instant messaging application (software) in the form of a client running on the device 12.

The messaging system 10 has one or more processors, such as CPUs, volatile memory, non-volatile data storage such as a hard disk(s) and/or non-volatile memory or the like, and one or more network interface circuits. The messaging system 10 has a messaging portion 14. The messaging system 10 may pass data to an external reporting portion 16, which may for example be used to carry out analysis on the data and/or provide reports on the data. The messaging portion 14 may in some examples be realised at least in part in the form of one or more servers.

As mentioned, there is also a growing demand for a messaging system that enables users to participate in different ways from what has been possible with known messaging systems. For example and as mentioned, in known messaging systems, users can send messages to other users, on a one-to-one basis. However, this is limiting. Moreover, if there is a large or very large number of users, this can place considerable demands on current technology that is available, in essence making known messaging systems unworkable or at least impractical when presented with large numbers of users.

In examples described herein, a category of user is defined and managed by the messaging system 10 in which the user is able to send messages to and receive messages from some organiser or representative of the group on a one-to-one basis, the user can receive messages from some organiser or representative of the group that are addressed to plural users, but the user is unable to send messages to other users. This type of user will be referred to herein as a “subscriber”, indicating that they have subscribed to this modified service (because they are interested in receiving communications from the group) and have not “joined” the group as a full participant or member (who can for example send messages to other members who have joined the group). On the other hand, each organiser or representative of the group will be referred to herein as an “administrator”.

As a specific example to illustrate this, the group may be operated by or on behalf of a company. An administrator may be for example a sales representative or a technical support person acting on behalf of the company. Subscribers may be people who are interested in receiving communications via a messaging system from the company and to answer polls or surveys or the like, or who may for example be requiring technical support for a product purchased from the company. As another example, the group may be for example operated by or on behalf of a local or regional or national government authority or the like. Subscribers may be people who are interested in receiving communications via a messaging system from the authority and to answer polls or surveys or the like set by the authority. In such cases, the number of subscribers may easily be thousands or tens of thousands, or even hundreds of thousands or a million or more.

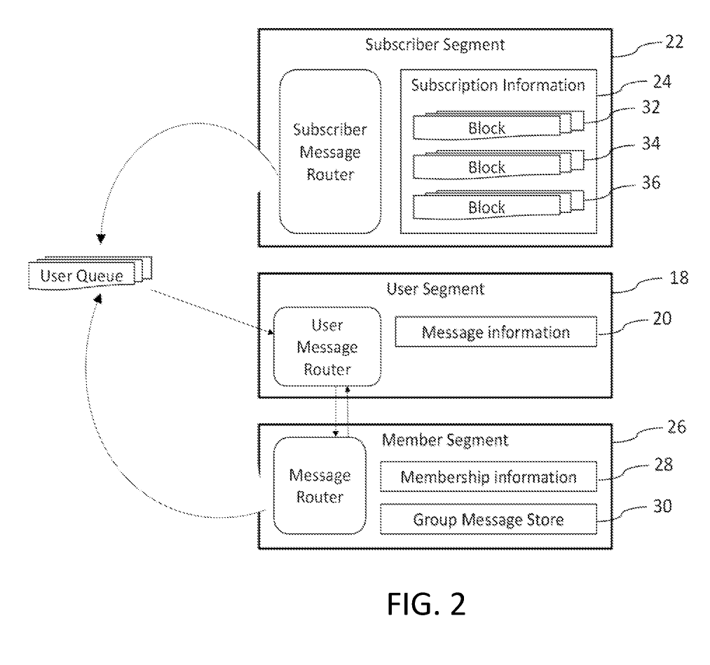

Referring now to FIG. 2 in addition to FIG. 1, the messaging portion 14 has a number of different segments to handle this. The term “segment” in this context is in some senses a logical structure. Nevertheless, the segments and their specific modes of operation (discussed further below) are controlled by one or more processors of the messaging system 10 to operate according to one or more rules, which are typically different between different segments.

The messaging portion 14 has one or more user segments 18. In an example, there is one user segment 18 for each subscriber of the messaging system 10. Each user segment 18 has data storage 20 for storing message information concerning messages received from the corresponding subscriber. In short, the user segments 18 allow subscribers to interact with the group on a one-to-one basis, as will be discussed further below.

The messaging portion 14 has a subscriber segment 22. Once a user has subscribed to a group, subscription information for the subscriber user is stored in data storage 24 of the subscriber segment 22. The subscription information includes at least contact information for the subscribers to enable messages to be sent to the subscribers and enable the source of a message received from a subscriber to be identified. The subscription information may also include details of for example one or more specific topics or subject matter that the subscriber has previously notified to the messaging system 10 as being topics for which the subscriber would like to receive messages concerning the topic(s).

The messaging portion 14 may also have a members segment 26. In this example, the members segment 26 has data storage 28 in which membership information for the administrators is stored. In one example, the membership information includes at least contact information for the one or more administrators of the group. The members segment 26 may also have data storage 30 for saving a copy of all messages sent by one administrator of the group to another administrator of the group. The members segment 26 may also optionally save a copy of all messages sent to and received from subscribers to the group in the data storage 30. Details of the administrators of the messaging group being serviced by the messaging system 10 is typically visible only to administrators, typically with some restrictions as to the information that is available for reasons of privacy.

The members segment 26 may also store membership information for users who have fully “joined” the group as a full participant or member, and who can for example send messages to and receive messages from other members who have joined the group, as well as send messages to and receive messages from administrators. The members segment 26 may save a copy of all messages sent by one full member to another and save a copy of all messages sent from a full member to an administrator and from an administrator to a full member.

Further structure and configurations for the various elements of the messaging system 10 will be described below, particularly in the context of the examples of use of the messaging system 10 described below.

In use, in terms of messages and other interactions which can be sent to and received from subscribers by administrators and messages and other interactions sent between administrators, the messaging system 10 is configured to provide four main types of interaction, as follows.

(i) subscriber to administrator interaction: this group topology allows subscribers to initiate an interaction with an administrator, without involving other subscribers in the interaction. For example, a subscriber can send a message intended for an administrator of the group. Other subscribers are not aware of this interaction, even though the other subscribers are interacting in the context of the same group.

(ii) administrator to subscriber interaction—reply: administrators are receivers of all communications of the first type mentioned above. The administrators are provided with the ability to send a message back to a subscriber as a reply to this type of message received from the subscriber. Only the subscriber who initiated the interaction can see this reply. Moreover, the format for the message that is sent by the administrator may be such that the subscriber sees the message in the context of the conversation started by the subscriber.

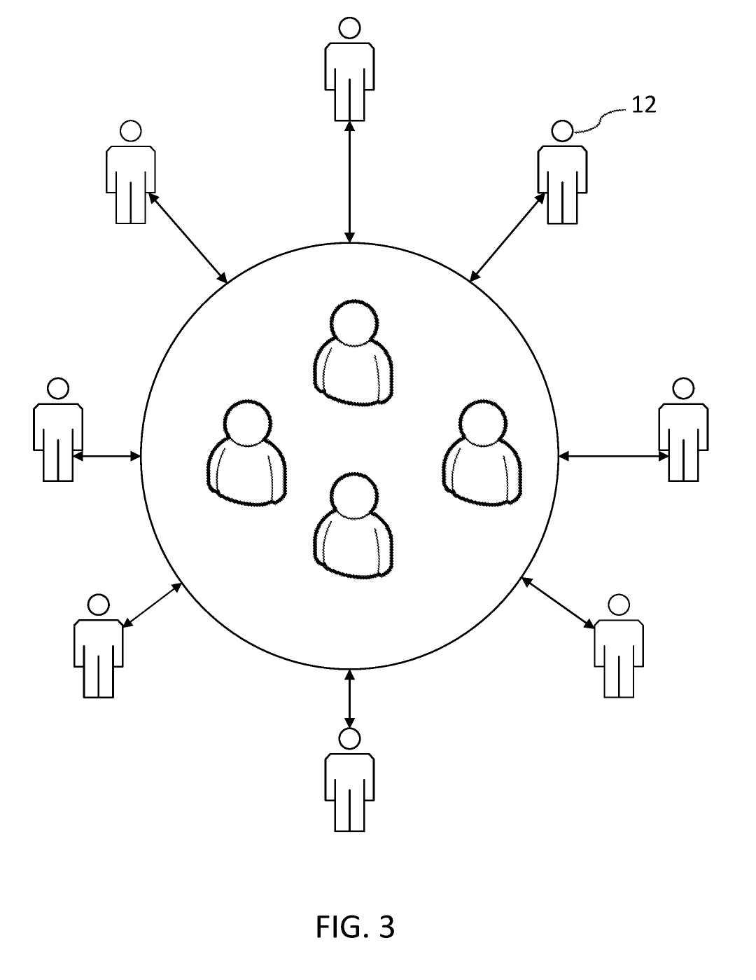

With this arrangement of first and second types of interactions, this example provides what may be termed a hub-spoke topology for communications between administrators and subscribers. Each subscriber may be regarded as being one spoke and the administrators may be regarded as being the hub. This is illustrated schematically in FIG. 3. This is in contrast to the ring model used in conventional messaging systems.

(iii) administrator to plural subscribers interaction: administrators are provided with the capability to send a message to plural subscribers, substantially simultaneously. This is akin to a “multicast”. These communications are particularly useful for things like questions (such as a poll or a survey) or other richer structured communications or just an announcement. All subscribers will receive and see this communication. Subscribers have the capability to reply back to this interaction, which will be treated as first type of interaction described above: such replies will be visible only to administrators, and not to other subscribers, in accordance with the rules for the first type of interactions discussed above.

(iv) administrator to administrator interaction: this enables communications between administrators, in a one-to-one format, similar to known conventional messaging systems. Subscribers do not receive and cannot view these interactions between administrators.

It may be noted that with these four basic types of interaction, in an example subscribers can send messages to administrators on a one-to-one basis, and subscribers can receive messages from administrators on a one-to-one basis or as a multicast (as discussed above), but subscribers are not able to send messages to other subscribers using the messaging system 10. This of itself provides significant features and advantages that are not possible with typical known messaging systems. For example, administrators can support a large number of individual unrelated interactions with subscribers in a group context. The interactions or conversations between an administrator and a subscriber may be formatted so as to appear to the subscriber as if the conversation is between the subscriber user and a virtual entity (i.e. the “group”), rather than some specific person (such as the human administrator). For the administrators, the experience is that the administrative users will see a bunch of messages/actions posted into the group, which are often to be acted upon one way or another by the administrators.

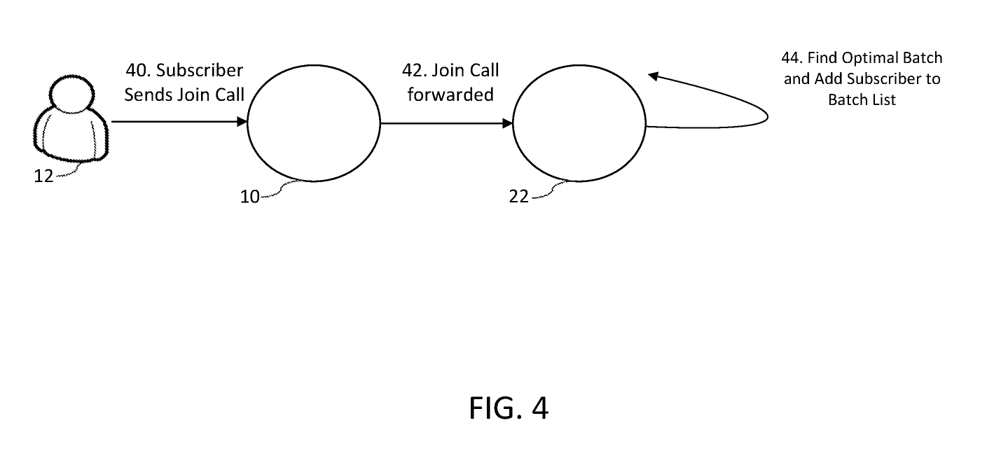

Referring now to FIGS. 4 to 6, examples of the flow of messages under control of the messaging system 10 will be described.

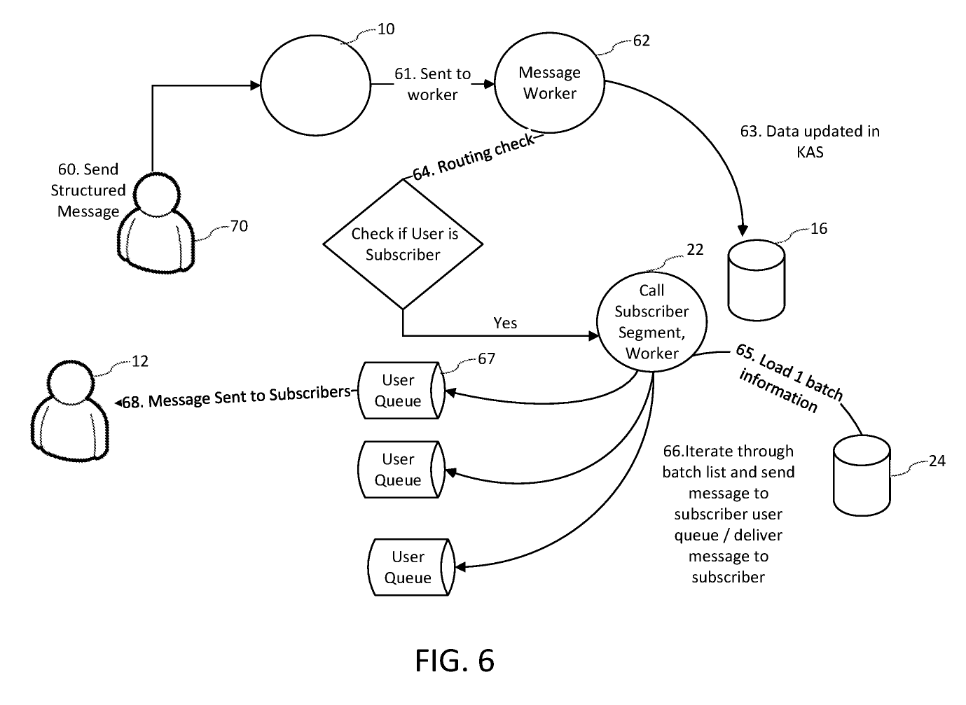

Referring first to FIG. 4, a user wants to become a subscriber to a particular messaging group that is being operated by the messaging system 10. The user device 12 sends 40 a “join call” message to the messaging system 10. The join call is received and forwarded 42 to the subscriber segment 22. Subscription information for the subscriber user is stored 44 in data storage 24 of the subscriber segment 22. This effectively makes the user a subscriber to the messaging group that is being operated by the messaging system 10. As part of this, an appropriate (logical) block 32, 34, 36 within the data storage 24 of the subscriber segment 22 is selected for storing the subscription information for the subscriber user. The relevance and importance of these blocks 32, 34, 36 will be discussed further below in relation in particular to FIG. 6.

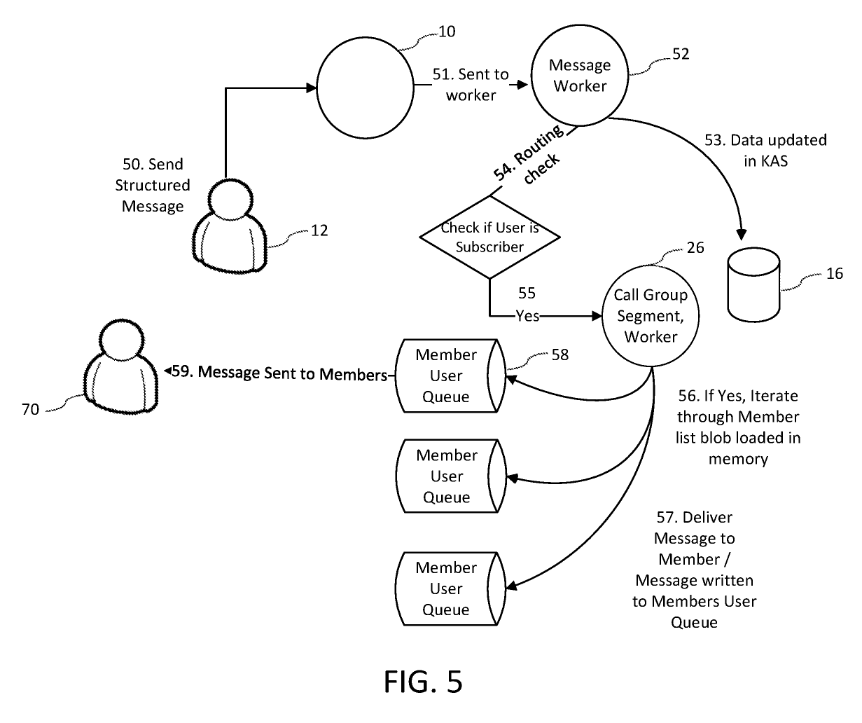

Referring to FIG. 5, an example of the flow of a message from a subscriber to the group will be described. This example corresponds to the first type of interaction discussed above and is indicated by an arrow with a solid line in FIG. 2.

A message, which may be a text message or a structured message, is sent 50 by a subscriber from a subscriber device 12 to the messaging system 10. (As opposed to a simple text message, a structured message allows data to be sent in the message in a form that can be easily stored, analysed and/or acted upon by for example the recipient, such as a message concerning or containing a survey, a task or a reminder or the like.) The message received by the messaging system 10 is sent 51 to a message worker 52, which may be for example implemented in software and which performs one or more supporting roles and processing of messages. The message worker 52 passes 53 data relating to the message, including for example details of the subscriber who sent the message and the content of the message, to data storage (such as part of the external reporting portion 16) of the messaging system 10 for possible analysis later, for example as part of an overall analysis of messages received over time from subscribers. In addition, a check is carried out 54 as to whether the sender of the message is recorded as a subscriber in the subscriber segment 22. If so, then the message is passed 55 to the members segment 26. The members segment 26 then selects 56 an administrator to whom the message is to be passed for an administrator to respond (if necessary) to the message from the subscriber. This may be carried out by the members segment 26 iterating through a list of administrators, which may be loaded in memory as a so-called blob (Binary Large Object). The members segment 26 delivers the message to the selected administrator or sends 57 the message to a user queue 58 for the selected administrator. From there, the message is sent 59 to the device or terminal 70 of the selected administrator.

Referring to FIG. 6, an example of the flow of a message from the group to a subscriber will be described. This example illustrates the sending of messages from the group to all of the subscribers This example corresponds to the third type of interaction discussed above and is indicated by an arrow with a dashed line in FIG. 2.

A message, which is typically a structured message, is sent 60 by an administrator subscriber from an administrator device 70 to the messaging system 10. The message received by the messaging system 10 is sent 61 to a message worker 62. The message worker 62 passes 63 data relating to the message, including for example details of the subscriber who sent the message and the content of the message, to data storage (such as part of the external reporting portion 16) of the messaging system 10 for possible analysis later, for example as part of an overall analysis of messages sent over time to subscribers. In addition, a check is carried out 64 for look for users who are recorded as subscribers in the subscriber segment 22. For the users who are recorded as subscribers, the message is passed 65 to the subscriber segment 22.

The subscriber segment 20 loads 65 block or batch information from the data storage 24 of the subscriber segment 22. That is, and referring briefly to FIG. 2 again, the data storage 24 of the subscriber segment 22 stores subscription information for the plural subscribers in (logical) blocks 32, 34, 36 . . . (with just three being shown for illustrative purposes). A first block 32 stores subscription information for a first set of the plural subscribers, the individual items of subscription information for the first set of the plural subscribers being indicated schematically by respective plural blocks 32, 34, 36, etc. A second block 34 stores subscription information for a second set of the plural subscribers, the individual items of subscription information for the second set of the plural subscribers again being indicated schematically by respective plural blocks. Further blocks for storing subscription information for further sets of subscribers are provided as necessary. An advantage of storing subscription information for the plural subscribers in (logical) blocks is that when a message is to be sent to all subscribers, the message can be sent to subscribers in batches or blocks, according to the subscribers whose information is stored in the respective blocks 32, 34, 36 . . . . This helps to save the messaging system 10, and possibly the network(s) or the like by which the messaging system 10 sends messages to subscribers, being overwhelmed by an attempt to send a message to all subscribers simultaneously. This is important in the present context where, as mentioned, there may be thousands up to potentially millions of subscribers to the group that is managed by the messaging system 10.

So, as mentioned, the subscriber segment 22 loads 65 block or batch information from the data storage 24 of the subscriber segment 22. That is, at least initially, the subscriber segment 22 loads 65 subscriber information for subscribers to whom the message should be sent as a first batch. The subscriber segment 22 iterates 66 through the list of subscribers in that first batch and sends 68 the message to the relevant subscribers (i.e. the user devices 12 of the subscribers concerned) in that first batch if the subscriber is online or passes the message to the user queues 67 of the subscribers in that first batch for the subscriber who are offline so that the message can then be sent 68 later to the relevant subscribers (i.e. the user devices 12 of the subscribers concerned) when the subscriber is online again. The subscriber segment 22 then loads 65 subscriber information for subscribers to whom the message should be sent as a second batch and this process repeated until the message has been sent to all subscribers.

In the case of a message that is to be sent from one administrator to another administrator as a one-to-one message (the fourth type of interaction discussed above), this can be handled along the lines carried out by conventional messaging systems. For this, membership information, including addressing information for the message, for the administrator concerned can be obtained from the data storage 28 of the members segment 26. Likewise, for a message that is to be sent to all subscribers (the third type of interaction discussed above) and that is also to be sent to all administrators, membership information, including addressing information for the message, for the administrator concerned can be obtained from the data storage 28 of the members segment 26. An administrator message router may be provided as part of the members segment 26 for routing messages to administrators. Messages sent from one administrator to another administrator may be stored in data storage (such as part of the external reporting portion 16) of the messaging system 10.

Particularly for a message that is to be sent to a number of subscribers (the third type of interaction discussed above), the subscribers who are to receive the batch or multicast message may be filtered such that only a subset of the subscribers receive the message. The filtering may be for example topic-based or content-based or a mixture of the two. In topic-based filtering, messages are published to “topics”, which may be regarded as named logical channels. Subscribers in a topic-based system will receive all messages published to the topics to which they subscribe, and all subscribers to a topic will receive the same messages. The administrator(s) may define the topics to which subscribers can subscribe to receive specific topic-based messages. In a content-based system, messages are only delivered to a subscriber if the content of those messages match constraints defined by the subscriber and registered with the messaging system.

Given the nature of the “hub-and-spoke” model used for communications between administrators and subscribers and the fact that there is typically a (very) large number of subscribers per administrators, there can be problems of message cluttering and volume of messages received for the administrators. To help the administrators deal with this and to enable multiple administrators to work in the group in parallel, in an example the messages/actions sent by subscribers can be partitioned into smaller subsets based on one or more criteria. The criteria may be for example action status, recipient information, type of message, round robin (in which subscribers are put into different categories on a rotation basis), etc.

Mention is made above of user queues, these being shown schematically in for example FIG. 2. As is known per se, user queues are sometimes used in messaging systems that only send messages to a user if the user is online at that time. If a recipient user is offline, then the message queue retains the message in the queue until the recipient user is online again and the message is then sent.

In an example, the messaging system 10 is configured so that the group is discoverable by users who are not (yet) subscribers or otherwise members of the group.

For example, the group may be made to be discoverable via for example internet search engines and the like, using for example names or tags that are made available to search engines.

As another example, a group may be made discoverable to users based on characteristics of the user. For example, the group may be made discoverable to users based on the location of the user such that only users who are located in or associated with a particular location can discover the group. This can be particularly useful when for example the group is run by or on behalf of a company that only provides local services, or if the group is run by or on behalf of a local or regional or national government authority or the like so that only users in the area covered by the authority can discover the group.

As another example, a group may be made discoverable to users based on the user reading a QR (quick response) or other code (such as a bar code) or using optical character recognition or the like using a user device 12 to scan the code or the like from some literature or other publication relevant to the group. The scanned code may be sent by the user device 12 to the messaging system 10 as part of the user's request send to the messaging system 10 to become a subscriber. Another example may similarly provide details of the group to a user device 12 as part of a transaction (e.g. a purchase) made using the user device 12 at a suitably configured point-of-sale device or some Internet-of-Things device.

Trust authorities may be used to certify discoverable groups. This can help order avoid spam and privacy and security issues. The trust authority may be for example “Active Directory”, which is a directory service developed by Microsoft Corporation for Windows domain networks.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

What is claimed is:

1. A messaging system providing for messaging interactions between users of a group, the system comprising:
a subscriber segment constructed and arranged to store subscription information for subscriber users, a subscriber user being a user who has subscribed to the group;
a user segment comprising a user message router constructed and arranged to receive messages from subscriber users for routing the messages received from subscriber users to one or more administrator users, an administrator user being a user who is an administrator of the group;
the messaging system being configured such that a message received from a subscriber user and intended for an administrator user is routed to an administrator user, the message not being visible to other subscriber users;
the messaging system being configured such that a message received from an administrator user and intended for a specific subscriber user is routed to the specific subscriber user, the message not being visible to other subscriber users;
the messaging system being configured such that a message received from an administrator user and intended for plural subscriber users is routed to the plural subscriber users; and
the messaging system being configured such that a subscriber user is unable to send a message to another subscriber user via the messaging system.

2. A messaging system according to claim 1, arranged such that a message received from an administrator user and intended for all of the plural subscriber users is routed to all of the plural subscriber users.

3. A messaging system according to claim 1, arranged such that a message received from an administrator user and intended for a filtered set of plural subscriber users is routed to the filtered set of plural subscriber users.

4. A messaging system according to claim 1, wherein the user segment is constructed and arranged to store message information for messages received from subscriber users.

5. A messaging system according to claim 4, wherein the user segment is constructed and arranged to store, for at least some messages, message information that includes at least the category of the subscriber user who sent the message.

6. A messaging system according to claim 1, wherein the subscriber segment is constructed and arranged to store subscription information for subscriber users in plural blocks, each block containing subscription information for a different subset of the subscriber users.

7. A messaging system according to claim 6, wherein the subscriber segment comprises a subscriber message router, the messaging system being configured such that a message received from an administrator user and intended for plural subscriber users is routed by the subscriber message router to the plural subscriber users in plural blocks corresponding to the plural blocks containing subscription information for different subsets of the subscriber users.

8. A messaging system according to claim 1, comprising a members segment, the members segment comprising a router arranged to route a message received from an administrator user and intended for other administrator users.

9. A messaging system according to claim 8, constructed and arranged to store membership information for administrator users, the router being arranged to route a message received from an administrator user and intended for other administrator users in accordance with the membership information stored for administrator users.

10. A messaging system according to claim 1, arranged such that the group is publicly discoverable by users who are not currently subscribers to the group.

11. A messaging system according to claim 10, arranged such that the group is publicly discoverable by users based on the location of the user.

12. A method of operating a messaging system for messaging interactions between users of a group, the system comprising a subscriber segment in which subscription information for subscriber users is stored, a subscriber user being a user who has subscribed to the group, and the system comprising a user segment comprising a user message router constructed and arranged to receive messages from subscriber users for routing the messages received from subscriber users to one or more administrator users, an administrator user being a user who is an administrator of the group, the method comprising:
receiving a message from a subscriber user and intended for an administrator user and routing the message to an administrator user such that the message is not visible to other subscriber users;
receiving a message from an administrator user and intended for a specific subscriber user and routing the message to the specific subscriber user such that the message is not visible to other subscriber users; and
receiving a message from an administrator user and intended for plural subscriber users and routing the message to the plural subscriber users,
wherein the messaging system is configured such that a subscriber user is unable to send a message to another subscriber user via the messaging system.

13. A method according to claim 12, comprising routing a message that is received from an administrator user and intended for all of the plural subscriber users to all of the plural subscriber users.

14. A method according to claim 12, comprising routing a message received from an administrator user and intended for a filtered set of plural subscriber users to the filtered set of plural subscriber users.

15. A method according to claim 12, comprising storing subscription information for subscriber users in plural blocks in the subscriber segment, each block containing subscription information for a different subset of the subscriber users.

16. A method according to claim 15, wherein the subscriber segment comprises a subscriber message router, the method comprising the subscriber message router routing a message that is received from an administrator user and intended for plural subscriber users to the plural subscriber users in plural blocks corresponding to the plural blocks containing subscription information for different subsets of the subscriber users.

17. A computer program product for a messaging system for messaging interactions between users of a group, the system comprising a subscriber segment in which subscription information for subscriber users is stored, a subscriber user being a user who has subscribed to the group, and the system comprising a user segment comprising a user message router constructed and arranged to receive messages from subscriber users for routing the messages received from subscriber users to one or more administrator users, an administrator user being a user who is an administrator of the group, the computer program product being embodied on a computer-readable storage device and configured so as when executed on a processor of the device to perform operations comprising:
receiving a message from a subscriber user and intended for an administrator user and routing the message to an administrator user such that the message is not visible to other subscriber users;
receiving a message from an administrator user and intended for a specific subscriber user and routing the message to the specific subscriber user such that the message is not visible to other subscriber users; and
receiving a message from an administrator user and intended for plural subscriber users and routing the message to the plural subscriber users,
wherein the messaging system is configured such that a subscriber user is unable to send a message to another subscriber user via the messaging system.

18. A computer program product according to claim 17, configured so as when executed on a processor of the device to perform routing a message that is received from an administrator user and intended for all of the plural subscriber users to all of the plural subscriber users.

19. A computer program product according to claim 17, configured so as when executed on a processor of the device to perform storing subscription information for subscriber users in plural blocks in the subscriber segment, each block containing subscription information for a different subset of the subscriber users.

20. A computer program product according to claim 19, wherein the subscriber segment comprises a subscriber message router, the computer program product being configured so as when executed on a processor of the device to perform the subscriber message router routing a message that is received from an administrator user and intended for plural subscriber users to the plural subscriber users in plural blocks corresponding to the plural blocks containing subscription information for different subsets of the subscriber users.
